(19) United States
(12) Patent Application Publication
(10) Pub. No.: US 2026/0342254 A1
(43) Pub. Date: Oct. 29, 2026

(54) METHOD FOR DETERMINING THE POSITION OF A ROTOR OF AN ELECTRIC MACHINE

(71) Applicant: MERCEDES-BENZ GROUP AG, Stuttgart (DE)

(72) Inventors: Julius ROGOWSKY, Sindelfingen (DE); Markus OTT, Aidlingen (DE)

(21) Appl. No.: 19/136,610

(22) PCT Filed: Nov. 30, 2023
(86) PCT No.: PCT/EP2023/083843

§ 371 Date: Jun. 6, 2025

(30) Foreign Application Priority Data
Dec. 7, 2022 (DE) 10 2022 004 573.7

(51) Int. Cl. H02P 21/18

(52) U.S. Cl. CPC H02P 21/18; H02P 2207/05

(57) ABSTRACT

The position of a rotor of an electric machine is determined without a rotor position sensor using an anisotropy-based position open-loop and/or closed-loop control algorithm with high-frequency excitation of the voltage modulation. A signal affected by measurement noise and having a minimum-disturbance slope tangent is calculated using a least squares algorithm that is able to identify high-frequency current derivatives. An angle control loop is also used for minimizing any occurring disturbance and jumps in the rotor angle. An amplitude-optimized high-frequency injection is also used.

### BACKGROUND AND SUMMARY OF THE INVENTION

Exemplary embodiments invention relate to a method for determining the position of a rotor of an electric machine.

An electric machine, for example a permanent magnet synchronous machine of a radial or axial arrangement or a current-excited synchronous machine, is operated by controlling a current in the electric machine by supplying a voltage. A known concept of current control is the field-oriented control which performs a transformation (Clarke-Park transformation) of current and voltage in a rotor-fixed coordinate system based on the position of the permanent magnets. The position of the permanent magnets (also rotor angle) is usually determined in this case via a rotor angle sensor (resolver). To save costs and installation space, the concept of sensorless control makes it possible to omit the sensors and to determine the rotor angle using only other sensor and machine parameters.

A known possibility for determining the rotor position is therefore provided by methods using the anisotropy of the electric machine. The degree of anisotropy R is determined via the inductances in the rotor-fixed coordinate system La and Lg and changes as a function of the operating point due to effects, such as the magnetic saturation:

$${R}_{L} ( {i}_{d} , {i}_{q} ) = \frac{{L}_{d} ( {i}_{d} , {i}_{q} )}{{L}_{q} ( {i}_{d} , {i}_{q} )}$$

A plurality of possibilities for determining the rotor angle by means of anisotropy are known from the literature, which incorporate an additional signal. In this case, the signal can be designed as a sine wave or rectangle and incorporated into the rotor-fixed or stator-fixed coordinate system as a voltage injection. Furthermore, possibilities are known proposing a current injection in the rotor-fixed coordinate system. Common to all of these methods is that additional high-frequency losses and additional torque undulations in the electric machine are incorporated by the injection, which negatively affect the efficiency and the noise, vibration, and harshness behavior (NVH). The aim is therefore to keep the injection as low as possible with simultaneously good and robust estimations of the rotor angle.

In addition to the classic high-frequency injection, it is known from the prior art that the modulation of the voltage with switching frequency can also be used directly as a high-frequency injection in addition to a separate high-frequency injection. The challenge with this method is the precise identification of the current derivatives within certain vectors of a switching period. In the academic literature, this identification is primarily achieved by an additional prototypical sensor system, which is not available in the automotive field. If the derivatives can be determined with a certain amount of accuracy, different possibilities exist to extract the rotor angle-dependent term. A known method is the so-called arbitrary injection [D. Paulus, P. Landsmann and R. Kennel, “Saliency based sensorless field-oriented control for permanent magnet synchronous machines in the whole speed range”, 3rd IEEE International Symposium on Sensorless Control for Electric Drives, 2012]. This divides the entire current derivative into an anisotropic high-frequency portion e^{αβ}, an isotropic high-frequency portion

$$\frac{d}{dt} {i}_{HF , Σ}^{αβ}$$

and a low-frequency portion

$$\frac{d}{dt} {i}_{LF}^{αβ} .$$

All the following observations are made in the stator-fixed coordinate system (αβ):

$${e}^{αβ} = \frac{d}{dt} {i}^{αβ} - \frac{d}{dt} {i}_{HF , Σ}^{αβ} + \frac{d}{dt} {i}_{LF}^{αβ}$$

$$\frac{d}{dt} {i}_{LF}^{αβ} = {Y}^{s} ( {R}_{S} {i}^{αβ} + {v}_{ω}^{αβ} )$$

$$\frac{d}{dt} {i}_{HF , Σ}^{αβ} = {Y}_{Σ} {v}^{αβ}$$

$$\frac{d}{dt} {i}_{HF , Δ}^{αβ} = {e}^{αβ} = {Y}_{Δ} S ( {Θ}_{R} ) {v}^{αβ}$$

Here, R_{S} denotes the stator resistance,

$${v}_{ω}^{αβ}$$

denotes the counter-induced voltage, Y_{Σ} denotes the isotropic (average) admittance, Y_{Δ} denotes the anisotropic admittance, Y^{s} denotes the admittance matrix, v^{αβ} denotes the voltage, if denotes the current in the respective vector, and S(Θ_{R}) denotes a transformation matrix depending on the rotor angle. Subsequently, the sinusoidal signal is calculated by means of the stator-fixed voltage and the extracted anisotropic high-frequency current derivatives, which signal has the same phase position as the rotor angle when harmonic anisotropies are neglected and cross-coupling effects are correctly compensated:

$${f}_{α} = {v}_{α} {e}_{α} - {v}_{β} {e}_{β} = {Y}_{Δ} ( {v}_{α}^{2} + {v}_{β}^{2} ) cos ( 2 {Θ}_{R} )$$

$${f}_{β} = {v}_{α} {e}_{β} + {v}_{β} {e}_{α} = {Y}_{Δ} ( {v}_{α}^{2} + {v}_{β}^{2} ) sin ( 2 {Θ}_{R} )$$

With subsequent application of an angle control loop, also angle tracking observer (ATO), [J. Friedmann, R. Hoffmann and R. Kennel, “A new approach for a complete and ultrafast analysis of PMSMs using the arbitrary injection scheme”, IEEE Symposium on Sensorless Control for Electrical Drives, 2016], occurring vibrations in the rotor angle are minimized. The influence of the cross-coupling is compensated via a table dependent on the id and iq current on the basis on the inductances in the d and q direction and the cross-coupled inductance L_{dq}(i_{d}, i_{q}), which is obtained from characterization data. The compensation term is calculated as follows:

$${λ}_{COMP} = 0.5 * atan ( - \frac{2 {L}_{dq} ( {i}_{d} , {i}_{q} )}{{L}_{q} ( {i}_{d} , {i}_{q} ) - {L}_{d} ( {i}_{d} , {i}_{q} )} )$$

Furthermore, it is known from the literature that identification of high-frequency current derivatives can performed by a least squares (LSQ) algorithm, [A. Liske, S. Decker and M. Braun, “Resource optimal FPGA implementation of a Least-Squares-Estimator for fast and robust online measurement of current slope and absolute value”, 21th European Conference on Power Electronics and Applications, 2019]. The fundamental idea here is that the current curve can be approximated as a linear equation \tilde{f}(t):

$$\tilde{f} ( t ) = {i}_{0 / 1 / 2 / 7} + \frac{d}{dt} {i}_{0 / 1 / 2 / 7} * t$$

By solving the linear regression equation and transformation by means of the arithmetic mean, the equation can be simplified so that, for example, this can be easily implemented on a freely programmable logic gate array (FPGA):

$$\frac{d}{dt} {i}_{0 / 1 / 2 / 7} = \frac{{\sum }_{k = 1}^{N} ( {ki}_{k} ) - \frac{N + 1}{2} {\sum }_{k = 1}^{N} ( {i}_{k} )}{{T}_{A} \frac{1}{6} N ( N + 1 ) ( 2 N + 1 ) - {T}_{A} {N ( \frac{N + 1}{2} )}^{2}} ,$$

where \tilde{f}(t) is the approximation function, iₖ is the inbound measuring value, T_{A} is the sampling interval, and N is the number of sampling values inside the desired vector T₀, T₁, T₂, or T₇. Furthermore, it is known from the literature that reconstruction of the active switching states can be used in the case of small modulation amplitude [P. Landsmann, J. Jung, M. Kramkowski, P. Stolze, D. Paulus and R. Kennel, “Lowering injection amplitude in sensorless control by means of current oversampling”, 3rd IEEE International Symposium on Sensorless Control for Electric Drives, 2012]. For this purpose, a start point of the first active vector and an end point of the second active vector are extracted from the surrounding zero vectors (backwards). The resulting average active vector has the same behavior in terms of current derivative and applied voltage as the individual vectors taken separately.

DE 10 2019 208 497 A1 describes a method for determining a rotor position of an electric rotating machine, injected by means of a PWM-controlled inverter. Specific injection voltages, which are composed of specified voltages and high-frequency voltages, are converted into corresponding PWM duty cycles and the inverter is controlled accordingly with these PWM duty cycles by a controller. Subsequently, current profiles of phase currents are determined by measuring at least one first phase current and a second phase current, wherein in each case measuring is carried out within a PWM period in the chronologically last third of a passive switching state. Subsequently, the rotor position is determined in accordance with the determined current profiles and the injected high-frequency voltages.

Exemplary embodiments of the invention are directed to a novel method for determining the position of a rotor of an electric machine.

In a method according to the invention for determining the position of a rotor of an electric machine without a rotor position sensor, an anisotropy-based position open-loop and/or closed-loop control algorithm with high-frequency excitation of the voltage modulation is used for estimating a rotor angle. According to the invention, furthermore, a signal affected by measurement noise and having a minimum-disturbance slope tangent is calculated using a least squares algorithm that is able to identify high-frequency current derivatives, wherein an angle control loop is also used for minimizing any occurring disturbance and jumps in the rotor angle, wherein an amplitude-optimized high-frequency injection is also used.

The present invention provides a method for operating and monitoring a permanent magnet synchronous machine without a rotor position sensor. In this manner, anisotropy-based estimation of the rotor position optimized with regard to NVH (noise, vibration, harshness) and efficiency is made possible without a rotor position sensor.

The present invention combines methods for determining the rotor position without a sensor in electric machines. In particular, high-frequency excitations of the voltage modulation are used by an arbitrary injection, calculated from a signal affected by measurement noise by means of an LSQ algorithm on a fast computing unit, and/or disturbances and jumps in the rotor angle occurring in an angle control loop are minimized. These aspects are combined and additionally an amplitude-optimized high-frequency injection is integrated in such a manner that an anisotropy-based determination of the rotor angle is possible with corresponding accuracy and robustness until downtime.

According to the invention, an anisotropy-based position open-loop and/or closed-loop control algorithm is used with modulation excitation without a sensor, together with a least squares algorithm (method of the least squares), which is able to identify high-frequency current derivatives. Additionally, an optimized injection scheme is proposed in order to ensure a stable and robust estimation at low machine speeds and with engine downtime. All three functionalities together enable the algorithm to be used in an engine control unit of a motor vehicle.

Eliminating a rotor position sensor provides advantages with regard to the costs, the installation space and the diagnostic effort.

### BRIEF DESCRIPTION OF THE DRAWING FIGURES

Exemplary embodiments of the invention are explained in more detail in the following using the drawings, which show:

FIG. 1 a schematic view of a method for estimating the rotor position for feedback into the field-oriented control,

FIG. 2 a schematic view of a method for estimating the rotor position for redundant monitoring of the rotor position,

FIG. 3 a schematic view of characteristic maps for operating point-dependent selection of frequency and amplitude of an injection,

FIG. 4 a schematic diagram of voltages and currents of an inverter for operating the electric machine, and

FIG. 5 a schematic view of an angle control loop.

Parts corresponding to each other are provided with the same reference signs in all the figures.

### DETAILED DESCRIPTION

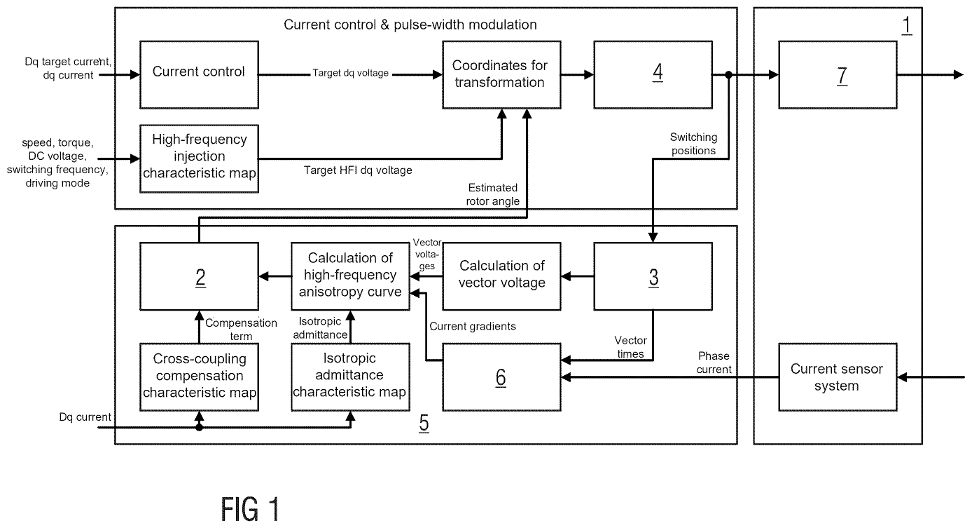

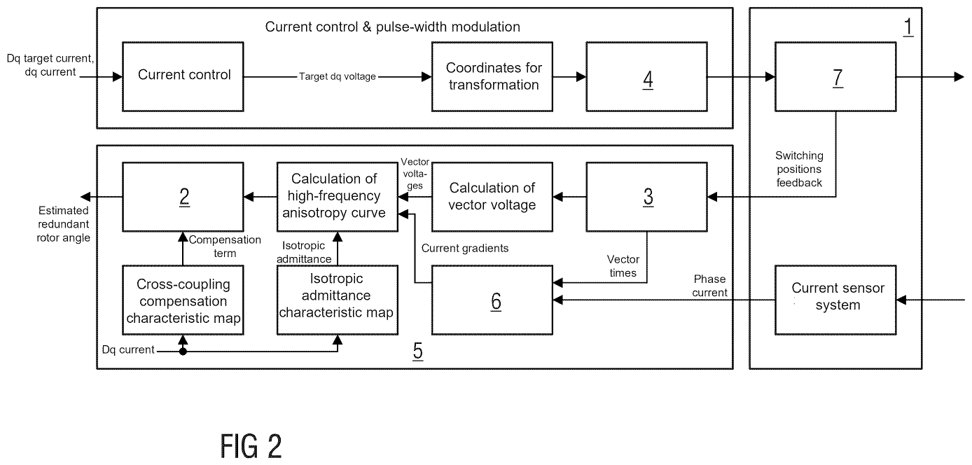

As described in the prior art, possibilities exist to estimate the rotor angle based on the anisotropy, in which the high-frequency excitations of the voltage modulation are used. In this case, a known method is that of arbitrary injection. Furthermore, it is known that a signal affected by measurement noise can be calculated by means of an LSQ algorithm 6 on a fast computing unit (for example FPGA) such that a minimum-disturbance slope tangent can be calculated. Lastly, the concept of the angle control loop 2 is known, which minimizes occurring disturbances and jumps of the rotor angle. The core of the invention is to carry out a novel combination of the individual aspects that were previously not included in the prior art, and additionally to integrate an amplitude-optimized high-frequency injection in such a way that an anisotropy-based determination of the rotor angle with corresponding accuracy and robustness is possible until downtime. For this purpose, there will be a distinction between case 1: Estimating the rotor position for feedback into the field-oriented control (FIG. 1) and case 2: Estimating the rotor position for redundant monitoring of the rotor position (FIG. 2). Depending on requirements placed on the electric drive and other determining factors, either one of the two methods or a combination of the methods is used.

FIG. 1 is a schematic view of a method for estimating the rotor position for feedback into the field-oriented control. FIG. 2 is a schematic view of a method for estimating the rotor position for redundant monitoring of the rotor position.

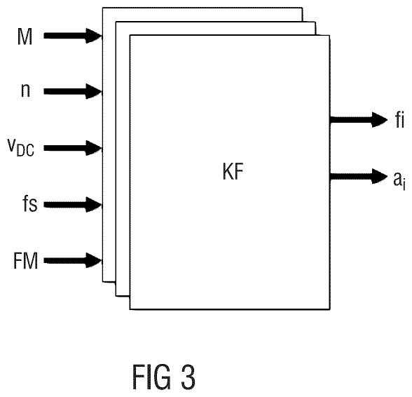

While a dedicated operating point-dependent high-frequency injection (FIG. 3) is used in case 1, in order to ensure a good and robust estimation of the rotor position in the case of small modulation, in case 2 a dedicated injection is not used, as an existing high-frequency injection from another algorithm can be accessed. In case 1, the injection is rectangular in order to achieve an almost constant level of modulation in contrast to other forms (e.g., sinusoidal). FIG. 3 is a schematic view of characteristic maps KF for operating point-dependent selection of frequency fᵢ and amplitude aᵢ of the injection in case 1. The operating point-dependent selection of frequency fᵢ and amplitude aᵢ of the injection in case 1 is determined as a function of torque M, speed n, DV voltage V_{DC} and the switching frequency fₛ as well as the driving mode FM by means of at least one characteristic map KF. In particular, by taking into account the driving mode FM, a distinction can be made between efficiency-, comfort- and performance-optimal injection.

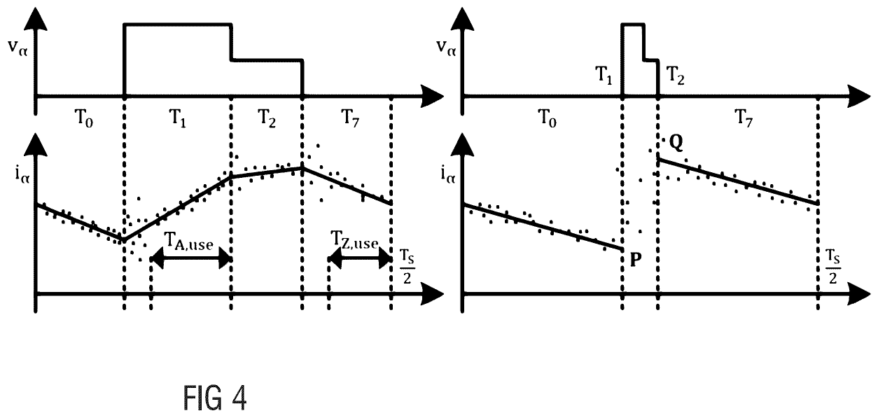

FIG. 4 is a schematic diagram of voltages v_{α} and currents i_{α} of an inverter 1 for operating the electric machine.

Information about the rotor angle is found in the anisotropic high-frequency portion of an active vector T₁, T₂, and is extracted by means of calculating the difference between the other parts, as shown in the prior art. In this case, the voltage state is referred to as an active vector T₁ or T₂, in which the inverter 1 is not in the freewheel mode. It comprises the six switching states 100, 110, 010, 011, 001, and 101, wherein a 1 stands for a closed switch and 0 stands for an open switch in the upper portion of a half bridge. In this case T₁ always refers to the first active vector of a new switching period and T₂ always refers to the second. The freewheeling states are defined as a zero vector (000 or 111), wherein To is always denotes the zero vector at the start of a new switching period and T₇ always denotes the zero vector in the middle of a switching period.

The isotropic high-frequency portion is calculated via the calculated voltages in the active vector being considered T₁, T₂ and is calculated depending on d and q currents by means of multiplication in an average admittance characteristic map. The low-frequency portion is extracted from the long zero vector T₇. The characteristic map of the isotropic (average) admittance Y_{Σ}(i_{d}, i_{q}) is calculated from the inductance characteristic maps which can be obtained, for example, by an offline characterization of the electric machine:

$${Y}_{Σ} ( {i}_{d} , {i}_{q} ) = \frac{1}{2} ( \frac{1}{{L}_{d} ( {i}_{d} , {i}_{q} )} + \frac{1}{{L}_{q} ( {i}_{d} , {i}_{q} )} )$$

An overview of the vectors is given in FIG. 4, on the left, for half a switching period. The longer of the two active vectors T₁, T₂, denoted by T_{A,use}, is always selected for the active vectors T₁, T₂. T₇ is always selected for the zero vector, denoted by T_{Z,use}. If the long active vector T₁, T₂ is shorter than a defined threshold, as explained, it is known from the prior art that a reconstruction of the average active vector T₁, T₂ can be made by evaluating both zero vectors T₀ and T₇. For this, the points P and Q on the right in FIG. 4 are reconstructed and the average current derivative is calculated with the knowledge about the length of the two active vectors T₁, T₂. By means of defining a minimum vector length of the longer active vector T₁, T₂, it is decided whether to use direct determination from the long active vector T₁, T₂ or the determination by means of reconstruction.

The vector selection 3 is identical in the two mentioned cases, wherein only the input signal differs. Based on the inbound signal, the duty cycles are extracted, and the current vector position is determined. The vectors are then prepared by means of incrementation and sorting such that the right vectors (long active vector T₁, T₂, long zero vector T₀, T₇) are selected. An evaluation is also carried out as to whether the method of the reconstruction of the average active vector T₁, T₂ is used. After selecting and sorting, the LSQ algorithm 6 is triggered accordingly, and the voltage level of the individual vector is provided on the basis of a table calculated offline and compensated for component-specific voltage drops. The triggers of the LSQ algorithm 6 start with a power semiconductor-dependent defined delayed start time, in order to minimize the influence of current overshoots.

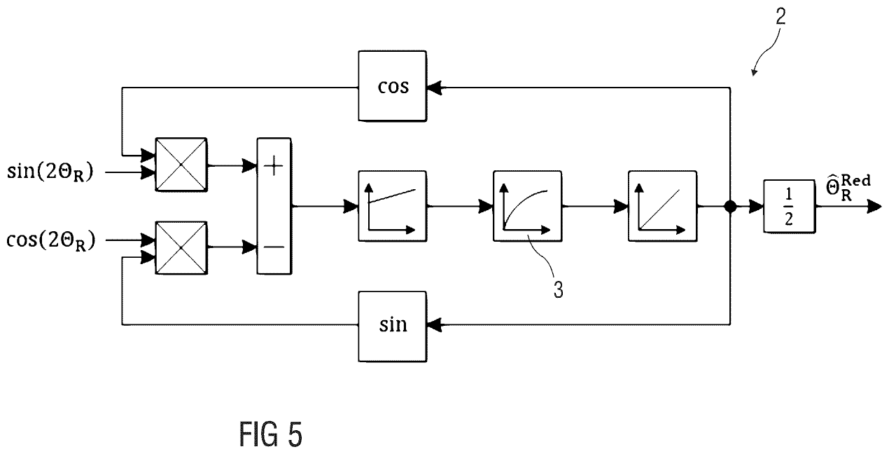

FIG. 5 is a schematic view of an angle control loop 2.

With the present anisotropic high-frequency portion from the long/average active vector T₁, T₂ and the associated voltage, a transformation is carried out as described in the prior art. The transformed signal with a similar phase position is then further processed by means of an angle control loop 2 expanded by an additional PT1 element and is compensated for the influence of cross-coupling.

The presented method is not restricted to the application with constant switching frequency and the space-vector modulation (SVPWM) modulation method. While a variable switching frequency fₛ primarily has an influence on the angle control loop 2, the arrangement or presence of the vectors changes when discontinuous methods are used. This is taken into account accordingly in a vector selection block 3, so that the method can be used for a large number of discontinuous methods (GDPWM, DPWMMIN, DPWMMAX, DPWM0, DPWM1, DPWM2, DPWM3).

In one embodiment, the method for operating a synchronous machine is carried out as shown in FIG. 1, wherein the synchronous machine is multi-phase and is injected via a power converter or inverter 1.

In one embodiment, an offline optimized operating point-dependent (in terms of torque M, speed n, DC voltage V_{DC}, power switching temperature, driving mode FM) specification of a minimum high-frequency rectangular injection takes place by means of several characteristic maps KF (see FIG. 3) with application-specific optimization targets. For example, one of the characteristic maps KF can have the optimization target efficiency, another can have the optimization target comfort and another can have the optimization target dynamics.

In one embodiment, switching positions calculated in a component pulse-width modulation 4 are transferred to a sensorless algorithm 5 for identifying a relevant vector characteristic, i.e. vector lengths, vector start points and vector end points, and for calculating the resulting voltage levels inside individual vectors.

In one embodiment, the sensorless determination of the rotor position occurs by combining the method of the arbitrary injection and a least squares algorithm 6, wherein the long active vector T₁, T₂ is used for the determination of the entire current derivative, wherein an offline table calculated on the basis of d and q current is used for the compensation of the low-frequency portion of the long average zero vector To, T₇ and for the high-frequency isotropic portion.

In one embodiment, in accordance with power semiconductors of the inverter 1, a delayed start time of the least squares algorithm 6 is defined at the start of each vector for minimizing the influence of current overshoots.

In one embodiment, a connected angle control loop 2 is used for minimizing high-frequency vibrations in the estimated rotor position signal.

In one embodiment, a vector length-dependent switchover occurs between the direct calculation from the active long vector T₁, T₂ and the reconstruction from the average value of both active vectors T₁, T₂.

In one embodiment, a variable sequence control of the vector selection 3 and sorting is performed in order to handle discontinuous modulation processes.

In one embodiment, a method for monitoring a permanent magnet synchronous machine as shown in FIG. 2 is carried out, wherein the synchronous machine is multi-phase and is injected via a power converter or inverter 1 and is operated at least partially via a classical anisotropy-based method of high-frequency injection.

In one embodiment, readback of the switching positions occurs at gate drivers 7 of the inverter 1 for identifying the vector times and resulting voltage levels inside individual vectors for compliance with security-relevant requirements.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 inverter
2 angle control loop
3 vector selection
4 pulse-width modulation
5 sensorless algorithm
6 least squares algorithm, LSQ algorithm
7 gate driver
aᵢ amplitude of the injection
fᵢ frequency of the injection
FM driving mode
fₛ switching frequency
i_{α} current
KF characteristic map
M torque
n speed
P point
Q point
T₀ zero vector
T₁ active vector
T₂ active vector
T₇ zero vector
T_{A,use} selected active vector
T_{Z,use} selected zero vector
VDC DC voltage
V_{α} voltage

1-9. (canceled)

10. A method for determining a position of a rotor of an electric machine, the method comprising:
estimating a rotor angle of the rotor of the electric machine using an anisotropy-based position open-loop or closed-loop control algorithm with high-frequency excitation of voltage modulation;
calculating, a signal affected by measurement noise and having a minimum-disturbance slope tangent, using a least squares algorithm that is able to identify high-frequency current derivatives;
minimizing, using an angle control loop, any occurring disturbance and jumps in the rotor angle;
using an amplitude-optimized high-frequency injection;
using the estimation of the rotor angle as feedback into field-oriented control or for redundant monitoring of the rotor angle depending on a requirement placed on the electric machine, wherein a high-frequency rectangular injection dependent on an operating point is used for feedback into the field-oriented control; and
determining an operating point-dependent selection of frequency and amplitude of the high-frequency rectangular injection by several characteristic maps as a function of a torque, a speed, a DC voltage, a switching frequency, and a driving mode,
wherein a distinction is made between efficiency-, comfort- and performance-optimal injection by taking into account the driving mode, and
wherein the method determines the position of the rotor of the electric machine without a rotor position sensor.

11. The method of claim 10, wherein high-frequency excitations of the voltage modulation are generated by an arbitrary injection.

12. The method of claim 10, further comprising:
extracting, using differentiation, information about the rotor angle from an anisotropic high-frequency portion of an active vector, wherein the active vector is a voltage state in which an inverter is not in freewheel mode for controlling the electric machine;
calculating an isotropic high-frequency portion by multiplication using calculated voltages in the active vector under consideration and an average admittance characteristic map depending on d and q currents;
extracting a low-frequency portion from a long zero vector; and
calculating the average admittance characteristic map from inductance characteristic maps.

13. The method of claim 12, wherein the inductance characteristic maps are obtained by an offline characterization of the electric machine.

14. The method of claim 12, further comprising:
performing a transformation with the anisotropic high-frequency portion from a long or average active vector and an associated voltage, wherein the transformed signal with a similar phase position is then further processed by the angle control loop expanded by an additional PT1 element and is compensated for influence of cross-coupling.

15. The method of claim 10, wherein the method is performed using a permanent magnet synchronous machine as a prime mover of a vehicle.
